(19) United States
(12) Patent Application Publication
(10) Pub. No.: US 2009/0223321 A1
(43) Pub. Date: Sep. 10, 2009

(54) Vehicle Steering Wheel

(75) Inventor: Giovanni Stefani, Sassuolo (IT)

Correspondence Address: OBLON, SPIVAK, MCCLELLAND MAIER & NEUSTADT, P.C., 1940 DUKE STREET, ALEXANDRIA, VA, 22314, US

(73) Assignee: FERRARI S.P.A., MODENA (IT)

(21) Appl. No.: 11/658,874

(22) PCT Filed: Jul. 29, 2005
(86) PCT No.: PCT/IB2005/002609

§ 371 Date: May 14, 2009

(30) Foreign Application Priority Data
Jul. 30, 2004 (IT) BO2004A000484

(51) Int. Cl. B62D 1/04

(52) U.S. Cl. 74/552

(57) ABSTRACT

A steering wheel for a vehicle includes a circular member operated by a driver of the vehicle to control a steering shaft mounted for rotation inside a steering column, the free end of which is fitted with a box body for housing an air bag and having at least one control lever.

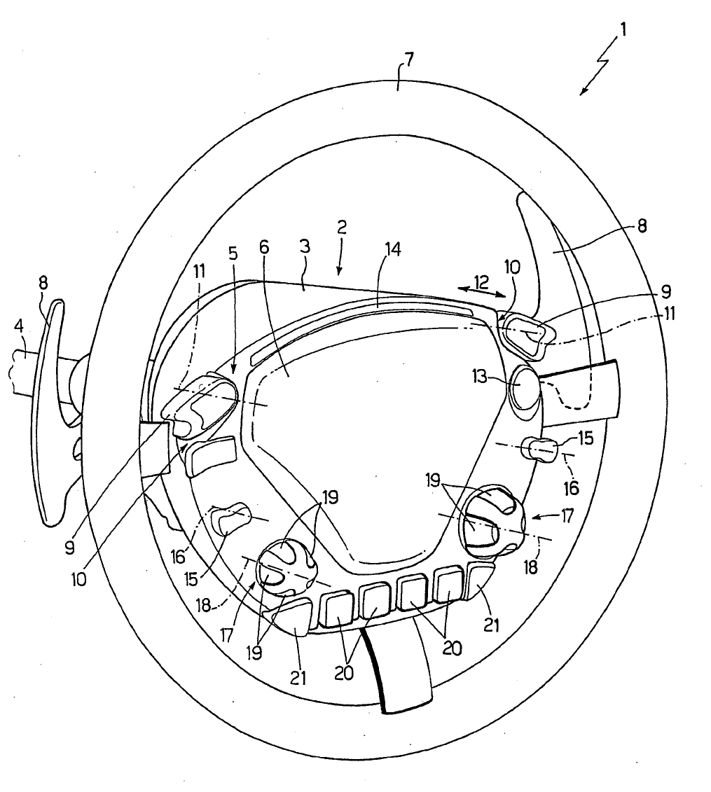

### TECHNICAL FIELD

The present invention relates to a vehicle steering wheel.

The steering wheel according to the present invention is particularly advantageous for use in high-performance sports vehicles, and comprises a box body fixed to the steering column of the vehicle and housing an air bag; and a circular member operated by the driver of the vehicle to control a steering shaft mounted for rotation inside the steering column.

The steering wheel also comprises at least one control lever projecting radially outwards from the steering column and for operating, for example, a direction indicator of the vehicle; and at least one actuating member mounted between said circular member and said control lever to operate the vehicle transmission.

### BACKGROUND ART

Since the control lever is operated by the driver of the vehicle with both hands on said circular member, known steering wheels of the above type have several drawbacks, mainly due to the control lever—because of its location on the steering column and with respect to the transmission actuating member—being relatively far away from the circular member and, hence, from the driver's hands. Operation of the control lever is therefore relatively awkward, and calls for a relatively small transmission actuating member to avoid further impeding grip of the control lever.

### DISCLOSURE OF INVENTION

It is an object of the present invention to provide a vehicle steering wheel designed to eliminate the above drawbacks, and which is cheap and easy to produce.

According to the present invention, there is provided a vehicle steering wheel as recited in Claim 1.

### BRIEF DESCRIPTION OF THE DRAWING

The present invention will be described with reference to the accompanying drawing, which shows a schematic view in perspective of a non-limiting embodiment.

### BEST MODE FOR CARRYING OUT THE INVENTION

Number 1 in the accompanying drawing indicates as a whole a steering wheel for steering the wheels (not shown) of a high-performance sports vehicle (not shown).

Steering wheel 1 comprises a box body 2 in turn comprising a substantially cup-shaped body 3 fixed to a free end of a steering column 4 and defining a cavity (not shown), which is positioned with its concavity facing the driver of the vehicle, opens outwards at a front face 5 of body 3, and is closed by a front cover 6 to define a chamber for housing an air bag (not shown).

Steering wheel 1 also comprises a circular member 7, which extends about body 3, is fitted in angularly fixed manner to a steering shaft (not shown) mounted for rotation inside steering column 4, and is operated by the driver of the vehicle to control the steering shaft (not shown) and so steer the wheels (not shown) of the vehicle.

Steering wheel 1 also comprises two actuating members 8 extending radially outwards from steering column 4 and by which the driver controls the transmission, of the vehicle. In a variation not shown, at least one of members 8 comprises indicator lights defined, for example, by LEDs and for indicating to the driver when to operate members 8 and, therefore, the vehicle transmission.

Body 2 also comprises two control levers 9, which are housed inside respective sunken seats 10 formed in a peripheral edge of face 5, and are located on opposite sides of a longitudinal plane of symmetry of body 2 and between members 8 and the driver.

Each lever 9 is fitted in rotary manner to body 3 to rotate with respect to body 3 about a given hinge axis 11, and is fitted in sliding manner to body 3 to perform straight movements with respect to body 3 in a direction 12 parallel to axis 11.

Levers 9 allow the driver to control auxiliary devices (not shown) of the vehicle, such as, for example, direction indicators, windscreen-wipers, and/or external lighting devices (not shown).

Face 5 is also fitted with a vehicle ignition switch 13; a luminous LED display 14; and, in the example shown, two switches 15, each of which is fitted in rotary manner to face 5 to rotate, with respect to body 2 and about an axis of rotation 16 substantially parallel to axes 11, between at least two operating positions, each corresponding to a respective dynamic performance of the vehicle.

Switches 15 therefore provide for selectively controlling the dynamic performance of the vehicle as a function of the driving style selected by the driver, e.g. for driving on very low-grip road surfaces, on low-grip road surfaces, on good-grip road surfaces, in safe touring conditions, or in on-track competition conditions.

Face 5 is also fitted with two knobs 17, each of which has a longitudinal axis 18 substantially parallel to axes 16, and has a number of (in the example shown, four) selection members 19, which are arranged about axis 18 and each allow the driver to select a respective. function of the vehicle, such as, for example, the volume of the vehicle radio, the air-conditioning/heating system fan, or other functions.

Each knob 17 is fitted in rotary manner to face 5 to rotate, with respect to body 2, about respective axis 18, and to selectively control the level of the function selected by members 19.

Steering wheel 1 also comprises a number of reconfigurable light buttons 20 arranged side by side and located between two selection buttons 21, which permit display of the selected vehicle function on buttons 20, such as, for example, different radio stations, or different CDs, or different interior vehicle lighting devices.

1-11. (canceled)

12. A steering wheel for a vehicle, comprising:
a box body fixed to a steering column of the vehicle and housing an air bag;
a circular member operated by a driver of the vehicle to control a steering shaft mounted for rotation inside the steering column; and
at least one control lever;
wherein the control lever is fitted to the box body.

13. A steering wheel as claimed in claim 12, wherein the control lever is fitted to the box body to rotate, with respect to the box body, about an axis of rotation.

14. A steering wheel as claimed in claim 12, wherein the control lever is fitted to the box body to perform straight movements, with respect to the box body, in a direction substantially parallel to an axis of rotation.

15. A steering wheel as claimed in claim 12, further comprising at least a first actuating member for controlling a transmission of the vehicle, the first actuating member being fitted to the steering column.

16. A steering wheel as claimed in claim 12, wherein the box body is bounded by a front face facing the driver of the vehicle, a plurality of second actuating members being mounted on the front face.

17. A steering wheel as claimed in claim 16, wherein the second actuating members comprise at least one switch fitted in a rotary manner to the box body to rotate, with respect to the box body, between at least two positions, each corresponding to a respective dynamic performance of the vehicle.

18. A steering wheel as claimed in claim 16, wherein the second actuating members comprise at least one knob, which comprises a plurality of selection members for selecting corresponding functions of the vehicle, and is mounted for rotation on the front face to selectively control a parameter of the function selected by the selecting members.

19. A steering wheel as claimed in claim 16, wherein the second actuating members comprise at least one selection button for selecting a function of the vehicle, and a plurality of reconfigurable light buttons, each for displaying the function selected by the selection button.

20. A steering wheel as claimed in claim 16, wherein the front face includes a luminous information display.

21. A steering wheel as claimed in claim 20, wherein the display is an LED display.

22. A steering wheel for a vehicle, comprising:
a circular member operated by a driver of the vehicle to control a steering shaft mounted for rotation inside a steering column;
at least one actuating member for controlling a transmission of the vehicle; and
luminous indicator means located on the actuating member to inform the driver of the need to activate the actuating member.
